(19) United States
(12) Patent Application Publication
(10) Pub. No.: US 2021/0090063 A1
(43) Pub. Date: Mar. 25, 2021

(54) LOCATION-BASED MONEY TRANSFER

(71) Applicant: Wells Fargo Bank, N.A., San Francisco, CA (US)

(72) Inventors: Mohammed Ahmed, Newark, DE (US); Robin M. Carter, Bear, DE (US); Megan Collins, Westfield, NJ (US); H. Brock Kolls, Alpharetta, GA (US); Minhthe Luu, Mount Laurel, NJ (US); David Patron, San Francisco, CA (US); Sarah W. Phelps, Annapolis, MD (US); Barry Trexler, San Francisco, CA (US)

(21) Appl. No.: 15/816,016

(22) Filed: Nov. 17, 2017

Related U.S. Application Data
(60) Provisional application No. 62/440,389, filed on Dec. 29, 2016.

(51) Int. Cl. G06Q 20/32; G06Q 20/10

(52) U.S. Cl. CPC G06Q 20/3224; G06Q 20/10

(57) ABSTRACT

Examples described herein relate to apparatus and methods for transferring funds based on location including, but not limited to, receiving, by a financial institution computing system, a location-based transfer request from a first user device associated with a first user, wherein the location-based transfer request comprises at least an identification of a location, a transfer amount, and an identification of a second user, wherein the second user is a recipient of the location-based transfer request, determining, by the financial institution computing system, that a second user device is at the location, wherein the second user device is associated with the second user; and in response to determining that the second user device is at the location, initiating, by the financial institution computing system, a transfer of the transfer amount to an account associated with the second user.

### CROSS-REFERENCE TO RELATED APPLICATION

This application claims priority to U.S. Provisional Patent Application No. 62/440,389 entitled “LOCATION-BASED MONEY TRANSFER,” filed Dec. 29, 2016, and incorporated herein by reference in its entirety.

### BACKGROUND

Online banking transfers and digital transfers allow a transferor to transfer money to a transferee without being in physical proximity of the transferee. However, such transfers do not allow the transferor to control a manner in which the money is transferred, other than designating the transferee, a date of transfer, and/or a transfer amount.

### SUMMARY

In some examples, a method for transferring funds based on location includes, but not limited to, receiving, by a financial institution computing system, a location-based transfer request from a first user device associated with a first user, wherein the location-based transfer request comprises at least an identification of a location, a transfer amount, and an identification of a second user, wherein the second user is a recipient of the location-based transfer request, determining, by the financial institution computing system, that a second user device is at the location, wherein the second user device is associated with the second user, and in response to determining that the second user device is at the location, initiating, by the financial institution computing system, a transfer of the transfer amount to an account associated with the second user.

In some arrangements, a financial institution computing system includes a network interface structured to facilitate data communication via a network, a memory, and a processing circuit comprising a processor, the processing circuit configured to receive a location-based transfer request from a first user device associated with a first user, wherein the location-based transfer request comprises at least an identification of a location, a transfer amount, and an identification of a second user, wherein the second user is a recipient of the location-based transfer request, determine that a second user device is at the location, wherein the second user device is associated with the second user, and in response to determining that the second user device is at the location, initiating a transfer of the transfer amount to an account associated with the second user.

These and other features, together with the organization and manner of operation thereof, will become apparent from the following detailed description when taken in conjunction with the accompanying drawings.

### BRIEF DESCRIPTION OF THE FIGURES

FIG. 1 is a diagram of a system for location-based money transfer from a first user to a second user according to an example embodiment.

FIG. 2A is a diagram of a financial institution computing system according to an example embodiment.

FIG. 2B is a diagram of a user device set forth in FIG. 1 according to an example embodiment.

FIG. 3 is a flow diagram illustrating a location-based transfer method according to an example embodiment.

FIG. 4A-4C are interface display diagrams illustrating interactive interfaces for receiving user input in connection with the location-based transfer according to an example embodiment.

FIG. 5 is a flow diagram illustrating a location-based transfer method involving a holding account according to an example embodiment.

FIG. 6 is a flow diagram illustrating a location-based transfer method involving direct transfer between user devices according to an example embodiment.

FIG. 7 is a flow diagram illustrating a location-based transfer method involving transfers to an account associated with a designated location according to an example embodiment.

### DETAILED DESCRIPTION

Referring generally to the FIGS., arrangements described herein relate to apparatus and methods for location-based digital money transfer with improved security and control. Traditionally, transfer of money from one party to another party occurs during in-person meetings, where one party physically delivers the money (e.g., cash, check, etc.) to another. The advent of the digital age allows money to be transferred digitally, thus allowing two individuals to transfer money from one to another even though they do not physically meet. For example, a parent who lives far away from a child can digitally transfer money to the child without being physically next to the child (e.g., via PayPal® or another peer-to-peer payment system). However, such digital transfers pose security and control concerns. For instance, given that the parent is not present when the child receives the money, the parent may not be sure if the money is actually received by the child, or if the child is actually using the money for its intended purposes. Additional network resources and processing power are typically consumed to validate the transferee or to control the manner in which the transferred money is used, thus resulting in waste. Arrangements described herein seek to improve current digital money transfer mechanisms.

Specifically, by allowing money transfer to take place based on location data, such as Global Position System (GPS) data, security and control with respect to digital money transfers can be improved. For example, a transferor (e.g., someone who transfers his or her own money) who is concerned about an identity of a transferee (e.g., someone who receives the money from the transferor) can designate a location at which the intended transferee is at, thus preventing other parties outside of the location from being able to obtain the transfer. In addition, the transferor can control the usage of the money by the transferee. Some examples described herein relate to allowing the transferor to designate a location, such that the transfer can be completed upon the transferee (e.g., a transferee's device) being at the location. Such arrangements allow money transfers (e.g., payments) to be tied to the location. In an illustrative scenario, a construction contractor who is being paid for renovation on a house can receive the money transfer when being in or near the house. In another illustrative scenario, a child who is receiving lunch money from a parent can receive the lunch money when being in or near a school cafeteria. In additional arrangements, a transferor can transfer to a merchant occupying the designated location instead of a transferee in response to the transferee being at the location. Accordingly, arrangements described herein allow remote control of money transfer by a transferor to ensure safe transfer and usage, without being physically present.

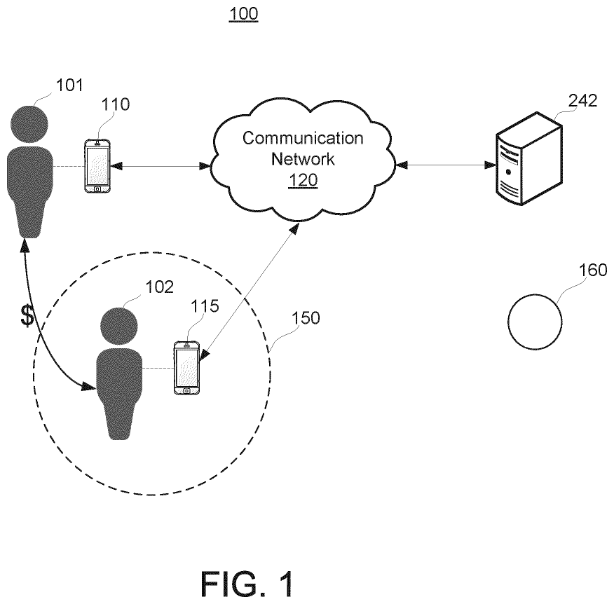

FIG. 1 is a diagram of an example of a system 100 for location-based money transfer from a first user 101 to a second user 102 according to some arrangements. Referring to FIG. 1, the first user 101 intends to transfer money to the second user 102 upon determination that the second user 102 is at a location 150. The first user 101 operates a first user device 110. The second user 102 operates a second user device 115. At least the second user device 115 can determine a location of the second user device 115, which is the location of the second user 102. A boundary defines the location 150, such that the second user 102 is deemed to be at the location 150 in response to determining that the second user device 115 is within the boundary that defines the location 150. The boundary of the location 150 is in turn defined by a set of location data (e.g., GPS coordinates, Bluetooth beacon identifier, wireless network information, address, street intersections, or the like) that delineates the boundary of the location 150. On the other hand, in response to determining that the second user device 115 is not at the location 150 (e.g., the second user device 115 is at position 160 outside of the boundary defining the location 150), the money transfer from the first user 101 to the second user 102 cannot occur.

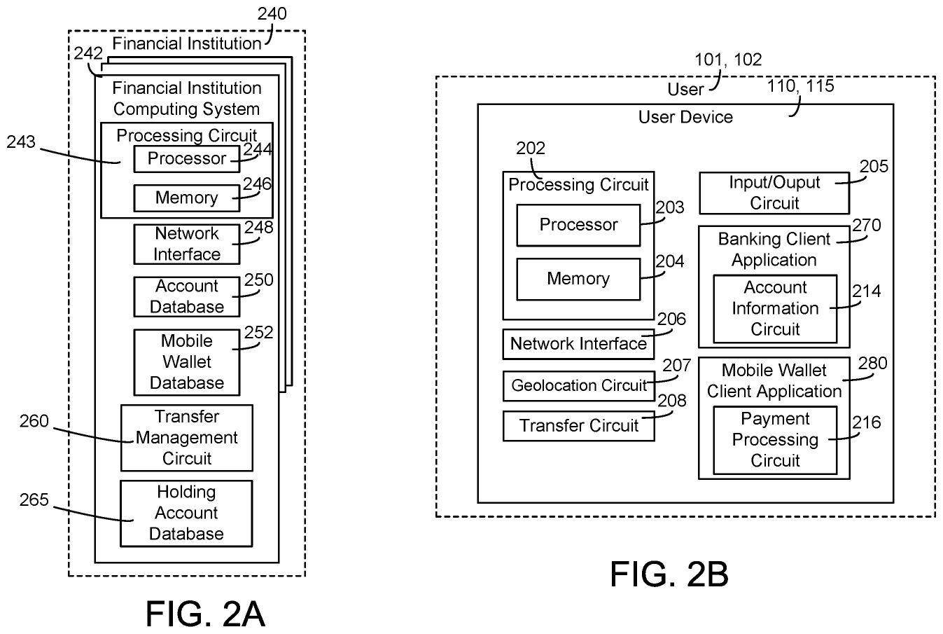

A server 130 facilitates the location-based money transfer in some arrangements. For instance, the server 130 is a financial institution computing system 242 (FIG. 2A) associated with a financial institution 240 (FIG. 2A) of which one or both of the first user 101 or second user 102 is a customer. In some examples, the server 130 is a separate server having at least a processing circuit, network interface, transfer management circuit, or holding account database such as, but not limited to, those shown in FIG. 2A.

One or more of the first user device 110, the second user device 115, or the server 130 are connected therebetween via a communication network 120. The communication network 120 is any suitable Local Area Network (LAN) or Wide Area Network (WAN). For example, the communication network 120 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access lx Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The communication network 120 is structured to permit the exchange of data, values, instructions, messages, and the like between one or more of the first user device 110, the second user device 115, or the server 130.

The user 101 designates at least the location 150 and a transfer amount using a user interface of the first user device 110. The location 150 can be any arbitrary definable location including a financial institution, an automatic teller machine (ATM), a branch location, a commercial location, a residential location, an industrial location, or any location on earth. In some arrangements, the first user device 110 sends a transfer request that contains the location 150 and the transfer amount to the server 130. As noted above, the second user 102 must be within the location 150 (as determined by the second user device 115) to receive the funds from the first user 101. In some arrangements, the server 130 can temporarily store the transfer amount in a holding account (e.g., an escrow count) while the location of the second user device 115 is being monitored. The server 130 receives location data of the second user device 115 and determines whether the second user device 115 is at the location 150. In response to determining that the second user device 115 is at the location, the server 130 adds the transfer amount to a financial account (e.g., a checking account, saving account, investment account, retirement account, or the like) associated with the second user 102 and/or a mobile wallet account supported by the second user device 115 and/or the server 130.

In some arrangements, the first user device 110 sends the transfer request directly to the second user device 115, such as in a mobile wallet direct transfer. In such arrangements, the second user device 115 determines its own location and allows the transfer amount to be added to a financial account or a mobile wallet supported by the second user device 115 in response to determining that the second user device 115 is at the location 150.

FIG. 2A is a diagram of a financial institution computing system 242 according to some arrangements. Referring now to FIGS. 1 and 2A, a financial institution 240 includes one or more of a bank branch, loan office, mortgage office, financial services office, retail office, ATM location, a combination thereof, and/or the like. The financial institution 240 has at least one associated financial institution computing system, which is the financial institution computing system 242 in some arrangements. The financial institution computing system 242 is a non-limiting example of the server 130 in some arrangements.

The financial institution 240 provides financial products and services such as, but not limited to, credit card accounts, checking/saving accounts, retirement accounts, mortgage accounts, loan accounts, investment and financial accounts, and the like to a customer via a financial institution computing system (e.g., the financial institution computing system 242). In some examples, one or more of the first user 101 or the second user 102 is an account holder of at least one financial account at the financial institution 240 and can use a respective first user device 110 or second user device 115 to access financial products and/or services provided by the financial institution 240. Particularly, as a customer of the financial institution 240, one party can make financial transactions (e.g., payments, deposits, transfers, or the like) with another party using the first user device 110 and/or the second user device 115.

In some arrangements, the financial institution computing system 242 accesses financial information of the first user 101 and/or the second user 102. If one or more of the first user 101 or the second user 102 is not a customer of the financial institution 240 with which the financial institution computing system 242 associates, the financial institution computing system 242 is coupled to a financial institution computing system of the different financial institution for accessing financial information (e.g., account data, mobile wallet data, or the like) for the transfers described herein. Specifically, the financial institution computing system 242 can facilitate withdrawing funds from a first account and depositing the funds into a second account. In some arrangements, at least one of the first or second accounts is maintained by the financial institution 240. In other arrangements, at least one of the first or second accounts is maintained by a financial institution other than the financial institution 240

The financial institution computing system 242 includes a processing circuit 243 having a processor 244 and a memory device 246. The processor 244 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 246 (e.g., Random Access Memory (RAM), Read-Only Memory (ROM), Non-volatile RAM (NVRAM), Flash Memory, hard disk storage, etc.) stores data and/or computer code for facilitating at least some of the various processes described herein. The memory 246 is or includes tangible, non-transient volatile memory or non-volatile memory. In this regard, the memory 246 stores programming logic that, when executed by the processor 244, controls the operations of the financial institution computing system 242. In some arrangements, the processing circuit 243 forms various processing circuits described with respect to the financial institution computing system 242 (e.g., the transfer management circuit 260). For example, the activities of multiple circuits are combined as a single circuit and implemented on a same processing circuit (e.g., the processing circuit 243), as additional circuits with additional functionality are included, etc.

As shown, the financial institution computing system 242 includes a network interface 248. The network interface 248 is structured for sending and receiving of data over the communication network 120 (e.g., to and from the first user device 110, the second user device 115, etc.). Accordingly, the network interface 248 includes any of a cellular transceiver (for cellular standards), local wireless network transceiver (for 802.11X, ZigBee, Bluetooth, Wi-Fi, or the like), wired network interface, combination thereof (e.g., both a cellular transceiver and a Bluetooth transceiver), and/or the like.

The financial institution computing system 242 includes an account database 250 that stores customer information and account information relating to one or more accounts managed by the financial institution 240. In this regard, more than one financial institution with an associated financial institution computing system can be communicably coupled to the components of FIG. 2A over the communication network 120 to access the accounts. Similarly, the components of FIG. 2A can likewise be coupled to such financial institution computing systems for accessing accounts of other customers involved in the transfer. In some examples, the account database 250 stores information relative to an originating account. As referred to herein, an originating account is an account of the first user 101 from which the transfer amount is drawn. In some examples, the account database 250 stores information relative to a receiving account (i.e., a beneficiary account). A receiving account is an account associated with the second user device 115 (e.g., an account of the second user 102) that receives the transfer amount in some arrangements. In some examples, the account database 250 stores information relative to an account associated with the location 150 or an account of a merchant occupying and doing business on the location 150. In the scenario that one or more of the originating account, receiving account, or account associated with the location 150 is not with the financial institution 240, the financial institution computing system 242 can interface with another financial institution to facilitate the transfer in the manner described.

The financial institution computing system 242 includes a mobile wallets account database 252 for storing mobile wallet accounts of associated customer. The mobile wallet accounts permit payments via a mobile wallet client application 280 of the user devices 110 and/or 115. The mobile wallets account database 252 stores transaction history of transactions made by using the mobile wallet client application 280. The transaction information for each transaction includes one or more of a transaction amount, transaction time, other party in the transaction, or the like.

In some arrangements in which the financial institution computing system 242 is not associated with a financial institution (e.g., the financial institution 240), the financial institution computing system 242 does not have the account database 250 and the mobile wallet database 252. The financial institution computing system 242 is coupled to financial institution computing systems of the financial institutions of which the first user 101 and the second user 102 are customers to the access financial information (e.g., account data, mobile wallet data, or the like) for the transfer described herein.

The financial institution computing system 242 includes a transfer management circuit 260. The transfer management circuit 260 is capable of facilitating transfer in the manner described. The transfer management circuit 260 is operatively coupled to one or more of the components of the financial institution computing system 242. For example, the transfer management circuit 260 is coupled to the network interface 248 for communicating with the user devices 110 and/or 115 via the communication network 120. The transfer management circuit 260 is coupled to one or more of the account database 250 or mobile wallet database 252 to access information stored thereon. In some examples, the transfer management circuit 260 is implemented with the processing circuit 243. For example, the transfer management circuit 260 is implemented as a software application stored within the memory 246 and executed by the processor 244. Accordingly, such examples can be implemented with minimal or no additional hardware costs. However, other implementations rely on dedicated hardware specifically configured for performing operations of the transfer management circuit 260. In some arrangements, the transfer management circuit 260 is operatively coupled to other systems to facilitate interbank transfers, such as an ACH transfer system, a wire transfer system, a third-party account verification service (e.g., Early Warning Services®, clearXchange®, etc.).

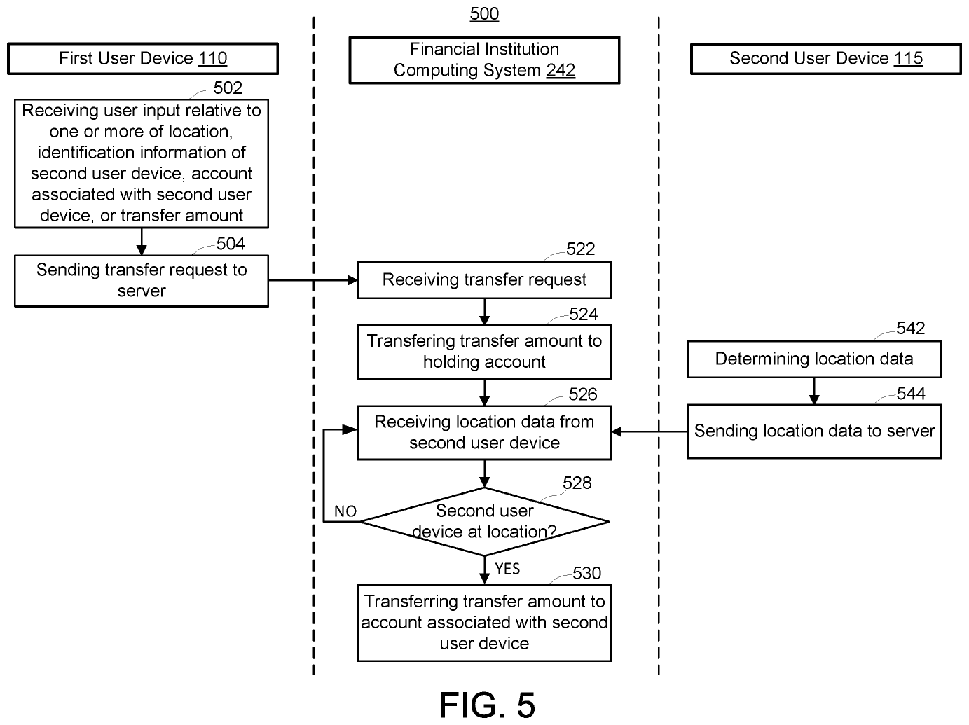

In some arrangements, the financial institution computing system 242 includes the holding account database 270. The holding account database 270 is capable of storing and managing holding account information. As described in detail with respect to FIG. 5, the holding account is an independent account managed by the financial institution computing system 242 that cannot be accessed by the first user 101 or the second user 102. A holding account can be generated for the purpose of escrowing a transfer amount for a given transfer, and may be deleted or closed in response to transfer success or transfer failure.

FIG. 2B is a diagram of the user device 110 or 115 set forth in FIG. 1 according to some arrangements. Referring to FIGS. 1-2B, the first user 101 operates the first user device 110. The second user 102 operates the second user device 115. Each of the first user device 110 and the second user device 115 includes one or more of the components shown in FIG. 2B. In particular, the second user device 115 includes the geolocation circuit 207, while the first user device 110 may or may not include the geolocation circuit 207.

In some arrangements, the user device 110 or 115 includes a processing circuit 202 having a processor 203 and memory 204. The processor 203 is implemented as a general-purpose processor, an ASIC, one or more FPGAs, a DSP, a group of processing components that are distributed over various geographic locations or housed in a single location or device, or other suitable electronic processing components. The memory 204 (e.g., RAM, NVRAM, ROM, Flash Memory, hard disk storage, etc.) stores data and/or computer code for facilitating the various processes described herein. Moreover, the memory 204 is or includes tangible, non-transient volatile memory or non-volatile memory. Accordingly, the memory 204 includes database components, object code components, script components, or any other type of information structure for supporting the various activities and information structures described herein.

The user device 110 or 115 is shown to include various circuits and logic for implementing the activities described herein. More particularly, the user device 110 includes one or more of a processing circuit 202, input/output circuit 205, network interface 206, transfer circuit 208, banking client application 270, mobile wallet client application 280, or the like. While various circuits, interfaces, and logic with particular functionality are shown, it should be understood that the user device 110 includes any number of circuits, interfaces, and logic for facilitating the functions described herein. For example, the activities of multiple circuits are combined as a single circuit and implemented on a same processing circuit (e.g., the processing circuit 202), as additional circuits with additional functionality are included, etc.

The network interface 206 of one of the user devices 110 and 115 is configured for and structured to establish a communication session via the communication network 120 with the financial institution computing system 242 or the other one of the user devices 110 and 115. Accordingly, the network interface 206 is an interface such as, but not limited to, the network interface 248.

The input/output circuit 205 is configured to receive user input from and provide information to one or more of the first user 101 or the second user 102. In this regard, the input/output circuit 205 is structured to exchange data, communications, instructions, etc. with an input/output component of the user device 110 or 115. Accordingly, in some arrangements, the input/output circuit 205 includes an input/output device such as a display device, touchscreen, keyboard, microphone, and/or the like. In some arrangements, the input/output circuit 205 includes communication circuitry for facilitating the exchange of data, values, messages, and the like between the input/output device and the components of the user device 110 or 115. In some arrangements, the input/output circuit 205 includes machine-readable media for facilitating the exchange of information between the input/output device and the components of the user device 110. In still another arrangement, the input/output circuit 205 includes any combination of hardware components (e.g., a touchscreen), communication circuitry, and machine-readable media.

One or more of the banking client application 270 or mobile wallet client application 280 are server-based applications executable on the user device 110 or 115. In this regard, the application is downloaded prior to usage. In another arrangement, the banking client application 270 and/or mobile wallet client application 280 are coded into the memory 204 of the user device 110 or 115. In still another arrangement, the banking client application 270 and/or mobile wallet client application 280 are web-based interface applications. In this configuration, the first or second user 101 or 102 has to log onto or access the web-based interface before usage. In this regard, at least one of the banking client application 270 and mobile wallet client application 280 is supported by a separate computing system comprising one or more servers, processors, network interface modules, etc. that transmit the applications for use to the user device 110 or 115. In certain arrangements, one or more of the banking client application 270 and/or mobile wallet client application 280 include an Application Programming Interface (API) and/or a Software Development Kit (SDK) that facilitate integration of other applications. All such variations and combinations are intended to fall within the spirit and scope of the present disclosure.

The banking client application 270 is communicably coupled to the financial institution computing system 242 (e.g., the account database 250) via the network 202 and is structured to permit management of at least one account via the banking client application 270. In this regard, the banking client application 270 provides displays indicative of account information such as, but not limited to, current account balances, pending transactions, profile information (e.g., contact information), reward associated with the account, bill pay information and/or the like. Further, in some arrangements, the banking client application 270 is configured to process payments from the first user 101 to a designated recipient (e.g., a second user 102). For example, the banking client application 270 depicts a loan (e.g., mortgage) and allows payment of the loan from an account (e.g., checking or savings). In some examples, a bill pay option is provided by the banking client application 270, where the bill pay option allows the first user 101 to pay his/her bills in response to user input.

As mentioned herein, via the banking client application 270, the first user 101 or the second user 102 pays bills (e.g., mortgage, etc.), view balances, and otherwise manage their account. Accordingly and as shown, the mobile bank client application 270 includes an account information circuit 214. The account information circuit 214 is linked or otherwise coupled to one or more accounts (as stored the account database 250) and permit management of the associated accounts (e.g., transfer balances between accounts, see payment history, etc.) by communicating with the financial institution computing system 242. The banking client application 270 is communicably coupled to the mobile wallet client application 280. As such, in response to a mobile payment via the mobile wallet client application 280, the mobile wallet client application 280 causes the banking client application 270 to update the payment account (i.e., the account that supported the mobile payment). As such, the applications 270 and 280 are communicably coupled to each other to enable actions supported by each respective application in some examples.

The mobile wallet client application 280 is communicably coupled to the financial institution computing system 242 (e.g., the mobile wallets database 252) via the communication network 120 and is structured to facilitate purchases and transfers by a customer (e.g., the first user 101) via the mobile wallet client application 280. Accordingly, the mobile wallet client application 280 is linked or otherwise connected with one or more accounts (as stored the account database 250) of the first user 101 or the second user 102 (e.g., the recipient). In operation, when at a point-of-sale terminal, a customer initiates the mobile wallet client application 280 and provides a passcode (e.g., biometrics such as a thumbprint, a Personal Identification Number (PIN), a password, etc.) to authenticate the customer and select the source payment account desired (e.g., a checking account from a particular financial institution that is linked to the mobile wallet client application 280). Via communication with the payment terminal (e.g., via near field communication), the aforementioned payment information is provided to the point-of-sale terminal or the merchant (e.g., via NFC, via barcode presentment, etc.) and the payment processed. Beneficially, carrying payment cards are avoided or reduced via the mobile wallet client application 280.

As mentioned herein, the mobile wallet client application 280 is structured to facilitate and permit payments by interfacing with an account held by the first or second user 101 or 102 at the financial institution 240. Accordingly, the mobile wallet client application 280 is communicably coupled via the network interface 206 over the communication network 120 to the financial institution computing system 242. As shown, the mobile wallet client application 280 includes a payment processing circuit 216 structured to facilitate payments by the first or second user 101 or 102 via the mobile wallet client application 280. For example, the payment processing circuit 216 enables a quick-pay capability with a merchant. In this regard, the payment processing circuit 216 includes or be communicably coupled with a communication device (e.g., a near-field communication chip) that facilitates the exchange of information between the mobile wallet client application 280 and a point-of-sale terminal.

In some arrangements, the user device 110 includes a transfer circuit 208. The transfer circuit 208 is operatively coupled to one or more of the components of the first or second user device 110 or 115. For example, the transfer management circuit 260 of one of the first and second user devices 110 and 115 is coupled to the network interface 206 for communicating information with the financial institution computing system 242 or another one of the first and second user devices 110 and 115 via the communication network 120. In some examples, the transfer circuit 208 is coupled to the input/output circuit 205 to display information concerning the transfer to the first or second user 101 or 102 and to receive user input via the input/output circuit 205 to relative to the transfer in the manner described.

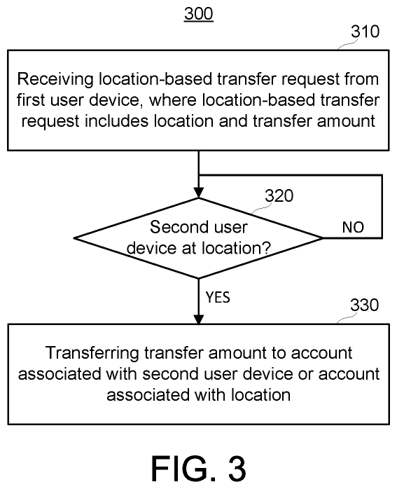

FIG. 3 is a flow diagram illustrating a location-based transfer method 300 according to various arrangements. Referring to FIGS. 1-3, the location-based transfer method 300 is generally concerned with receiving a location-based transfer request from the first user device 110, determining whether the second user device 115 is at the location 150 designated by the first user 101, and allowing the transfer to take place upon determination that the second user device 115 is at the location 150.

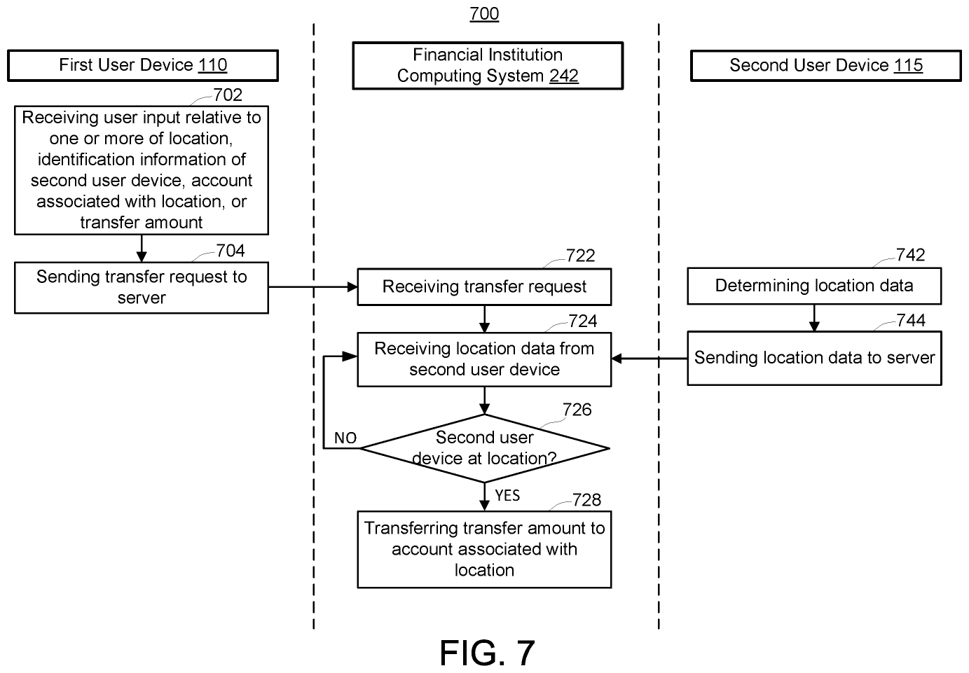

The location-based transfer method 300 is performed by the financial institution computing system 242 (e.g., the transfer management circuit 260) or the server 130 in some arrangements. Given that such arrangements concern financial information, centralized control of the location-based transfers by the financial institution computing system 242 is advantageous due to security measures (e.g., encryption, firewalls, security responses, or the like) of the financial institution computing system 242 that are in place for safeguarding the financial information. In addition, centralized processing at the financial institution computing system 242 allow processing resources to be conserved by the first user device 110 and the second user device 115. Such arrangements are described in further detail with respect to at least FIGS. 5 and 7.

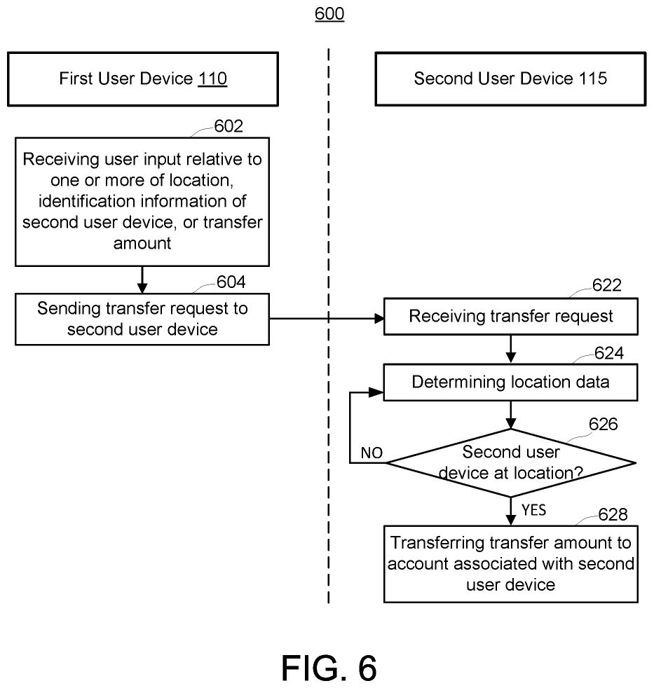

In other arrangements, the location-based transfer method 300 is performed by the transfer circuit 208 of the second user device 115. For example, transfers can be made between virtual mobile currency carriers (e.g., the mobile wallet client application 280 of the first user device 110 and the mobile wallet client application 280 of the second user device 115) for expedited processing, without routing through the financial institution computing system 242. The transfer can be updated with the financial institution computing system 242 concurrently or thereafter, to assure that the financial institution computing system 242 acknowledges the transfer. Such arrangements are described in further detail with respect to at least FIG. 6.

At 310, a location-based transfer request is received from the first user device 110. The location-based transfer request includes at least an indication of the location 150 and the transfer amount. In some examples, the transfer request further includes identification information (e.g., a phone number, IP address, or the like) of the first user device 115, for the financial institution computing system 242 and the second user device 115 to identify the source of the transfer request. The location 150 can be designated by the first user 101 through the input/output circuit 205 of the first user device 110. The location 150 represents a preferred location at which the second user 102 has to be at in order for the transfer to take place. As described, the location 150 can be any definable arbitrary location. In some examples, the location 150 is associated with or occupied by the financial institution 240, an automatic teller machine (ATM) of the financial institution 240, a branch location of the financial institution 240, or the like. In other examples, the location 150 (e.g., a parking lot, a store, a park, a commercial property, a residential property, an industrial property, or the like) is not occupied by the financial institution 240 or a branch thereof. The location 150 is defined by one or more of GPS coordinates, Bluetooth beacon identifier, wireless network information, address, street intersections, or the like that delineates the boundary of the location 150

In some arrangements in which the financial institution computing system 242 performs the location-based transfer method 300, the financial institution computing system 242 receives the location-based transfer request. In some arrangements in which the second user device 115 performs the location-based transfer method 300, the second user device 115 receives the location-based transfer request.

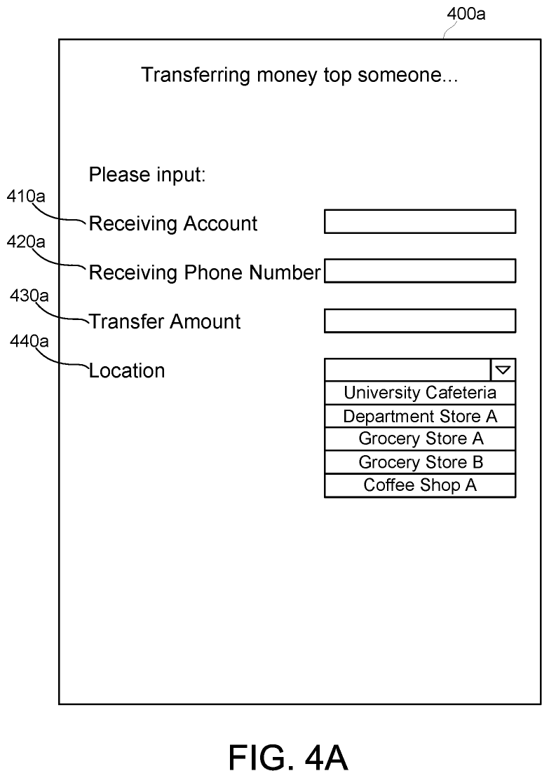

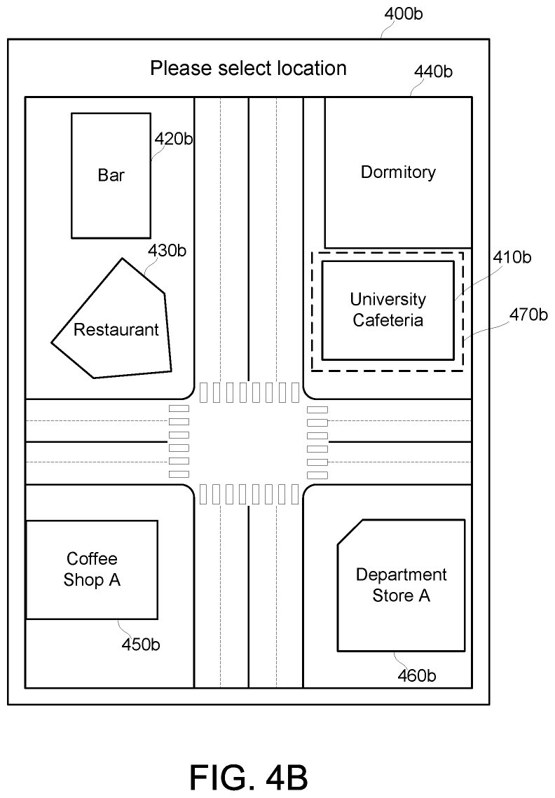

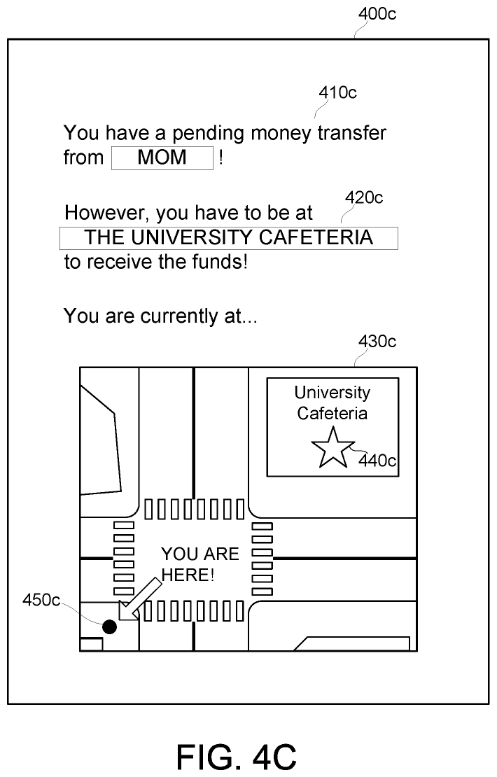

At 320, determination of whether the second user device 115 is at the location 150 indicated in the transfer request is performed. In some arrangements in which the financial institution computing system 242 performs the location-based transfer method 300, the transfer management circuit 260 receives location data from the second user device 115 via the network interface 248 and makes the determination based on the location data. For instance, the transfer management circuit 260 compares a location defined by the location data to the location 150 indicated in the transfer request. If the location of the second user device 115 is within the boundary defining the location 150, the second user device 115 is deemed to be at the location 150. Illustrating with a non-limiting example, in response to determining that the second user device 115 is at a location within a boundary (e.g., a boundary 470b of FIG. 4B) associated with the location 150, the first user 101 is deemed to be at the location 150. In some arrangements in which the second user device 115 performs the location-based transfer method 300, the transfer circuit 208 of the second user device 115 monitors its own location data outputted by the geolocation circuit 207 and makes the determination based on the location data.

In response to determining that the second user device 115 is not at the location 150 (320:NO), the method 300 returns to block 320. On the other hand, in response to determining that the second user device 115 is at the location 150 (320:YES), the transfer amount is transferred to an account associated with the second user device 115. In some arrangements, in response to determining that the second user device 115 is at the location 150 (320:YES), the transfer amount is transferred to an account associated with the location 150. In some examples, the account associated with the second user device 115 refers to a financial account (e.g., a checking account, saving account, investment account, retirement account, or the like) and/or a mobile wallet account held by the second user 102. Access to the financial account and/or the mobile wallet account is supported by the second user device 115 (e.g., the banking client application 270, the mobile wallet client application 280, or the like of the second user device 115). The account associated with the location 150 refers to an account of a merchant occupying and doing business on the location 150.

FIG. 4A is an interface display diagram illustrating an interactive interface 400a for receiving user input in connection with the location-based transfer according to some arrangements. Referring to FIGS. 1-4A, the interactive interface 400a is displayed to the first user 101 via the input/output circuit 205 of the first user device 110. The interactive interface 400a is displayed in response to the first user 101 indicating that a transfer is desired, by selecting a corresponding user interactive element (not shown).

The interactive interface 400a is used to obtain user input relative to one or more of the location 150, identification information of the second user device 115, account associated with the second user device 115, or transfer amount. For instance, the interactive interface 400a includes a user interactive element 410a for receiving the account (e.g., an account number, account identifier, or the like) associated with the second user device 115 and/or the second user 102. The interactive interface 400a includes a user interactive element 420a for receiving the identification information (e.g., a phone number, account identifier, or the like) of the second user device 115. The interactive interface 400a includes a user interactive element 430a for receiving the transfer amount. The interactive interface 400a further includes a user interactive element 440a for receiving the location 150. The user interactive element 440a is configured in the non-limiting example shown in FIG. 4A as a drop-down menu including identifiers of previously inputted or nearby locations, business names, entities, or the like.

FIG. 4B is an interface display diagram illustrating an interactive interface 400b for receiving user input in connection with the location-based transfer according to some arrangements. Referring to FIGS. 1-4B, the interactive interface 400b is displayed to the first user 101 via the input/output circuit 205 of the first user device 110. The interactive interface 400b is displayed to obtain user input relative to selection of the location 150. For instance, the interactive interface 400b includes a map having user interactive elements 410b-460b that correspond to various locations shown on the map. In some examples, by selecting one (e.g., the user interactive element 410b) of the user interactive elements 410b-460b, a boundary 470b corresponding to the selected element 410b is selected to define the location 150. The boundary 470b is predetermined for each location in some examples, such that the boundary 470b is automatically defined by one or more of the first user device 110 or the financial institution computing system 242 in response to receiving the location 150. The boundary 470b can be defined by predetermined radius (e.g., a predetermined boundary) from the location 150. In other examples, the first user 101 can designate (e.g., draw) the boundary 470b via the input/output circuit 205 of the first user device 110.

FIG. 4C is an interface display diagram illustrating an interactive interface 400c for receiving user input in connection with the location-based transfer according to some arrangements. Referring to FIGS. 1-4C, the interactive interface 400c is displayed to the second user 102 via the input/output circuit 205 of the second user device 115. The interactive interface 400c is displayed to notify the second user 102 that a location-based transaction is pending. For instance, the interactive interface 400c includes a user interactive element 410c for notifying a source (e.g., the first user 101) of the transfer. In the arrangements in which the financial institution computing system 242 or the first user device 110 sends information identifying the first user device 110, the source can be identified based on the information. The interactive interface 400c includes a user interactive element 420c for notifying the location 150 in some arrangements, so that the second user 102 is aware. The interactive interface 400c includes a user interactive element 430c for displaying the location 150 selected. In particular, the user interactive element 430c is a map showing a current location 450c of the second user device 115 and the location 150 (440c).

FIG. 5 is a flow diagram illustrating a location-based transfer method 500 involving a holding account according to various arrangements. Referring to FIGS. 1-5, the location-based transfer method 500 is an example implementation of the location-based transfer method 300. For instance, one or more of blocks 522-530 correspond to each of blocks 310-330. As shown, the location-based transfer method 500 is performed by the first user device 110, the financial institution computing system 242, and the second user device 115. The method 500 is generally concerned with the financial institution computing system 242 holding the transfer amount in a holding account after the transfer request is received from the first user device 110 and before the second user device 115 is detected to be at the location 150. In response to detecting that the second user device 115 is at the location 150, the transfer amount is transferred from the holding account to an account of the second user 102

At 502, the first user device 110 receives user input relative to one or more of the location 150, identification information of the second user device 115, account associated with the second user device 115, and/or transfer amount. The user input is received via the input/output circuit 205 of the first user device 110. For instance, the input/output circuit 205 of the first user device 110 presents interactive interfaces such as the interfaces 400a-400b for obtaining the user input.

At 504, the first user device 110 sends a transfer request to the financial institution computing system 242. The information contained in the transfer request includes the user input received at 502. For example, the transfer request includes one or more of the indication of the location 150, identification information of the second user device 115, account associated with the second user device 115, or transfer amount. The identification information of the second user device 115 includes, but not limited to, one or more of a phone number, IP address, or the like associated with the second user device 115. In some examples, the transfer request further includes identification information (e.g., a phone number, IP address, or the like) of the first user device 115, for the financial institution computing system 242 and the second user device 115 to identify the source of the transfer request. At 522, the financial institution computing system 242 receives the transfer request.

At 524, the transfer management circuit 260 of the financial institution computing system 242 transfers the transfer amount to a holding account. The holding account is an independent account managed by the financial institution computing system 242 that cannot be accessed by the first user 101 or the second user 102. For instance, the first user 101 or the second user 102 is not authorized and/or is not provided a channel to access the holding account via the first user device 110, the second user device 115, or another device. In some arrangements, the holding account is generated solely for the transfer between the first user 101 and the second user 102, and the holding account can be closed in response to completion of the transfer. The holding account constitutes a security feature that holds the transfer amount in escrow before determination of the location of the second user device 115. In some examples, the transfer amount is deducted from an originating account from which the transfer amount is drawn as the transfer amount is being deposited into the holding account. Upon determination of unsuccessful transfer (e.g., the first user device 115 fails to enter the location 150 within a period of time), the transfer amount is transferred from the holding account to the originating account of the first user 101.

At 526, the financial institution computing system 242 receives the location data from the second user device 115. In some arrangements, the second user device 115 determines location data at 542. That is, the second user device 115 uses the geolocation circuit 207 to determine a current location of the second user device 115. The location data includes, for example, GPS data, geographic coordinates, or the like. At 544, the second user device 115 (e.g., the network interface 206 of the second user device 115) sends the location data to the financial institution computing system 242.

In some arrangements, upon receiving the transfer request, the financial institution computing system 242 identifies the second user device 115 using the identification information of the second user device 115. In some arrangements, the financial institution computing system 242 identifies the second user device 115 based on the account associated with the second user device 115, by searching a lookup table stored in the memory 246. The lookup table maps correspondence between the account associated with the second user device 115 and the identification information of the second user device 115. Upon identification of the second user device 115, the financial institution computing system 242 sends a location request to the second user device 115 using the identification information. Upon reception of the location request, the second user device 115 periodically (e.g., every 5 s, 10 s, 30 s, 1 m, 2 m, 5 m, or the like) determines its current location data and sends the location data to the financial institution computing system 242 (at 544). In such arrangements, the location 150 designated by the first user 101 is not transmitted to the second user device 115 to prevent manipulation of the location data to conform to the location 150 for unauthorized access of the transfer.

In other arrangements, the location request includes the indication of the location 150. In such arrangements, the transfer circuit 208 of the second user device 115 determines whether the location of the second user device 115 is the same as the location 150 (e.g., within a boundary that defines the location 150) and sends a TRUE message instead of the location data in response to determining that the second user device 115 is at the location 150. This conserves network resources given that the second user device 115 does not need to periodically send the raw location data to the financial institution computing system 242 via the communication network 120.

At 528, the transfer management circuit 260 determines whether the second user device 115 is at the location 150. In response to determining that the second user device 115 is not at the location 150 (528:NO), the method 500 returns to block 526. On the other hand, in response to determining that the second user device 115 is at the location 150 (528:YES), the transfer management circuit 260 transfers the transfer amount to the account associated with the second user device 115, at 530. That is, the transfer management circuit 260 transfers the transfer amount from the holding account to a financial account or a mobile wallet account of the second user 102. The financial account or the mobile wallet account is identified in the transfer request. Then, the second user 102 can access the transfer amount via the banking client application 270, mobile wallet client application 280, or another suitable method.

In some examples, the transfer management circuit 260 of the financial institution computing system 242 initiates a cancellation timer upon receiving the transfer request at 522. In some arrangements, the duration of the cancellation timer is designated by the first user 101 via the input/output circuit 205 of the first user device 110 and included in the transfer request. In other arrangements, the duration of the cancellation timer is predetermined (e.g., 5 m, 30 m, 1 h, 2 h, 24 h, or the like). In response to determining that before the expiration of the cancellation timer, the second user device 115 has not been at the location 150, the transfer management circuit 260 cancels the transferring of the transfer amount. The transfer amount is deposited back to the originating account.

FIG. 6 is a flow diagram illustrating a location-based transfer method 600 involving direct transfer from the first user device 110 (FIG. 1) to the second user device 115 (FIG. 1) according to various arrangements. Referring to FIGS. 1-6, the location-based transfer method 600 is an example implementation of the location-based transfer method 300. For instance, one or more of blocks 622-628 correspond to each of blocks 310-330. As shown, the location-based transfer method 600 is performed by the first user device 110 and the second user device 115. The method 600 is generally concerned with direct transfer from the first user device 110 to the second user device 115, such as in a direct mobile wallet transfer from the mobile wallet client application 280 of the first user device 110 to the mobile wallet client application 280 of the second user device 115.

At 602, the first user device 110 receives user input relative to one or more of the indication of the location 150, identification information of the second user device 115, or transfer amount. The identification information includes, but not limited to, one or more of a phone number, IP address, or the like associated with the second user device 115. The user input is received via the input/output circuit 205 of the first user device 110. For instance, the input/output circuit 205 of the first user device 110 presents interactive interfaces such as the interfaces 400a-400b for obtaining the user input.

At 604, the first user device 110 sends a transfer request to the second user device 115. The information contained in the transfer request includes the user input received at 602. The network interface 206 of the first user device 110 routes the transfer request to the second user device 115 using the identification information of the second user device 115. The transfer request includes one or more of the location 150 or transfer amount. In some examples, the transfer request further includes identification information (e.g., a phone number, IP address, or the like) of the first user device 115, for the second user device 115 to identify the source of the transfer request. At 622, the second user device 115 receives the transfer request.

At 624, the second user device 115 determines the location data. That is, the second user device 115 uses the geolocation circuit 207 to determine a current location of the second user device 115 in the manner described. At 626, the transfer circuit 208 of the second user device 115 determines whether the second user device 115 is at the location 150 based on the location data. In response to determining that the second user device 115 is not at the location 150 (626:NO), the method 600 returns to block 624. On the other hand, in response to determining that the second user device 115 is at the location 150 (626:YES), the transfer circuit 208 of the second user device 115 transfers the transfer amount to an account associated with the second user device 115, at 628. That is, the transfer circuit 208 of the second user device 115 allows the transfer amount to be transferred from the originating account to a financial account or a mobile wallet account of the second user 102. The account associated with the second user device 115 can be one of the accounts supported by the banking client application 720 or the mobile wallet client application 280. The second user 102 can designate an account using the input/output circuit 25 of the second user device 115. Then, the second user 102 can access the transfer amount via the banking client application 270, mobile wallet client application 280, or another suitable method.

In some examples, the transfer circuit 208 of the second user device 115 initiates a cancellation timer upon receiving the transfer request at 622. In some arrangements, the duration of the cancellation timer is designated by the first user 101 via the input/output circuit 205 of the first user device 110 and included in the transfer request. In other arrangements, the duration of the cancellation timer is predetermined (e.g., 5 m, 30 m, 1 h, 2 h, 24 h, or the like). In response to determining that before the expiration of the cancellation timer, the second user device 115 has not been at the location 150, the transfer circuit 208 of the second user device 115 cancels the transferring of the transfer amount. In this scenario, the transfer amount does not move from the originating account.

FIG. 7 is a flow diagram illustrating a location-based transfer method 700 involving a transfer to an account associated with the designated location 150 (FIG. 1) according to various arrangements. Referring to FIGS. 1-7, the location-based transfer method 700 is an example implementation of the location-based transfer method 300. For instance, one or more of blocks 722-728 correspond to each of blocks 310-330. As shown, the location-based transfer method 700 is performed by the first user device 110, the financial institution computing system 242, and the second user device 115. The method 700 is generally concerned with the financial institution computing system 242 transferring the transfer amount from an originating account of the first user 101 to an account associated with an entity (e.g., a merchant) occupying and/or operating business at the location 150. The transfer amount is not deposited into an account associated with the second user 102. Accordingly, the first user 101 has improved transferor control of the money transferred, to make sure that the money is being used appropriately by the second user 102.

At 702, the first user device 110 receives user input relative to one or more of the indication of the location 150, identification information of the second user device 115, account associated with the location 150, or transfer amount. The user input is received via the input/output circuit 205 of the first user device 110. For instance, the input/output circuit 205 of the first user device 110 presents interactive interfaces such as the interfaces 400a-400b for obtaining the user input. In some examples, the first user 101 can directly input the account (e.g., an account number) associated with the location 150 if known. In other examples, the first user 101 can select the entity associated with the location 150 by selecting a user interactive element (e.g., one or more of the user interactive elements 410b-460b). In such examples, instead of the account associated with the location 150, a location identifier (e.g., a business name, code name, or the like) is included in the transfer request.

At 704, the first user device 110 sends a transfer request to the financial institution computing system 242. The information contained in the transfer request includes the user input received at 702. For example, the transfer request includes one or more of the indication of the location 150, identification information of the second user device 115, account associated with the location 150, or transfer amount. The identification information of the second user device 115 includes, but not limited to, one or more of a phone number, IP address, or the like associated with the second user device 115. In some examples, the transfer request further includes identification information (e.g., a phone number, IP address, or the like) of the first user device 115, for the financial institution computing system 242 and the second user device 115 to identify the source of the transfer request. At 722, the financial institution computing system 242 receives the transfer request.

In some arrangements, upon receiving the transfer request, the financial institution computing system 242 identifies the second user device 115 using the identification information of the second user device 115. In some arrangements, the financial institution computing system 242 identifies the account associated with the location 150 (e.g., a business account of a merchant occupying and operating a business at the location 150) based on the location identifier included in the transfer request, by searching a lookup table stored in the memory 246. The lookup table maps correspondence between the account associated with the location 150 and location identifier.

At 724, the financial institution computing system 242 receives the location data from the second user device 115. In some arrangements, the second user device 115 determines location data at 742 in a manner similar to described with respect to 542 and sends the location data to the financial institution computing system 242 at 744 in a manner similar to described with respect to 544.

At 726, the transfer management circuit 260 determines whether the second user device 115 is at the location 150. In response to determining that the second user device 115 is not at the location 150 (726:NO), the method 700 returns to block 724. On the other hand, in response to determining that the second user device 115 is at the location 150 (726:YES), the transfer management circuit 260 transfers the transfer amount to the account associated with the location 150, at 530. That is, the transfer management circuit 260 transfers the transfer amount from the originating account of the first user 101 to a financial account of the entity associated with the location 150.

In some examples, the transfer management circuit 260 of the financial institution computing system 242 initiates a cancellation timer upon receiving the transfer request at 722. In some arrangements, the duration of the cancellation timer is designated by the first user 101 via the input/output circuit 205 of the first user device 110 and included in the transfer request. In other arrangements, the duration of the cancellation timer is predetermined (e.g., 5 m, 30 m, 1 h, 2 h, 24 h, or the like). In response to determining that before the expiration of the cancellation timer, the second user device 115 has not been at the location 150, the transfer management circuit 260 cancels the transfer.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

1. A method, comprising:
receiving, by a financial institution computing system, a location-based transfer request from a first user device associated with a first user, wherein the location-based transfer request comprises at least an identification of a location via a global positioning satellite (GPS) system, a transfer amount, and an identification of a second user, wherein the second user is a recipient of the location-based transfer request;
determining, by the financial institution computing system, that a second user device is at the location based on location data identifying a location of the second user device, wherein the second user device is associated with the second user; and
in response to determining that the second user device is at the location and regardless of a location of the first user device, initiating, by the financial institution computing system, a transfer of the transfer amount to an account associated with the second user.

2. The method of claim 1, wherein:
the location-based transfer request is received at the financial institution computing system; and
the transfer amount is transferred by the financial institution computing system to the account associated with the second user device.

3. The method of claim 2, wherein determining whether the second user device is at the location comprises:
receiving, by the financial institution computing system, the location data of the second user device from the second user device.

4. The method of claim 2, further comprising:
adding the transfer amount from a first user account associated with the first user device to a holding account; and
transferring the transfer amount to the account associated with the second user device comprises transferring the transfer amount from the holding account to the account associated with the second user device.

5. The method of claim 4, further comprising in response to determining that the second user device is not at the location, holding the transfer amount in the holding account.

6. The method of claim 2, wherein the location-based transfer request further comprises identification information of the second user device or the account associated with the second user device.

7. The method of claim 2, further comprising:
sending a location request to the second user device in response to receiving the location-based transfer request; and
receiving the location data of the second user device from the second user device.

8. The method of claim 7, further comprising:
initiating a cancellation timer in response to sending the location request to the second user device;
determining that, before the expiration of the cancellation timer, the second user device is not at the location based on the location data; and
cancelling the transferring of the transfer amount.

9. The method of claim 1, wherein: the location-based transfer request is received at the financial institution computing system; and
the transfer amount is transferred by the financial institution computing system to an account associated with a merchant occupying the location.

10. The method of claim 9, wherein the location-based transfer request further comprises the account associated with the merchant.

11. The method of claim 1, wherein:
the location-based transfer request is received at the second user device; and
the transfer amount is transferred by the second user device to the account associated with the second user device.

12. The method of claim 11, wherein transferring the transfer amount to the account associated with the second user device comprises transferring the transfer amount from a first mobile wallet application on the first user device to a second mobile wallet application on the second user device.

13. A financial institution computing system, comprising:
a network interface structured to facilitate data communication via a network;
a memory; and
a processing circuit comprising a processor, the processing circuit configured to:
receive a location-based transfer request from a first user device associated with a first user, wherein the location-based transfer request comprises at least an identification of a location via a global positioning satellite (GPS) system, a transfer amount, and an identification of a second user, wherein the second user is a recipient of the location-based transfer request;
determine that a second user device is at the location based on location data identifying a location of the second user device, wherein the second user device is associated with the second user; and
in response to determining that the second user device is at the location and regardless of a location of the first user device, initiating a transfer of the transfer amount to an account associated with the second user.

14. The financial institution computing system of claim 13, wherein determining whether the second user device is at the location comprises:
receiving the location data of the second user device from the second user device.

15. The financial institution computing system of claim 13, wherein the processing circuit is further configured to:
add the transfer amount from a first user account associated with the first user device to a holding account; and
transferring the transfer amount to the account associated with the second user device comprises transferring the transfer amount from the holding account to the account associated with the second user device.

16. The financial institution computing system of claim 15, wherein the processing circuit is further configured to hold the transfer amount in the holding account in response to determining that the second user device is not at the location.

17. The financial institution computing system of claim 13, wherein the location-based transfer request further comprises identification information of the second user device or the account associated with the second user device.

18. The financial institution computing system of claim 13, wherein the processing circuit is further configured to:
send a location request to the second user device in response to receiving the location-based transfer request; and
receive the location data of the second user device from the second user device.

19. The financial institution computing system of claim 18, wherein the processing circuit is further configured to:
initiate a cancellation timer in response to sending the location request to the second user device;
determine that, before the expiration of the cancellation timer, the second user device is not at the location based on the location data; and
cancel the transferring of the transfer amount.

20. (canceled)

21. (canceled)

22. A non-transitory computer-readable medium storing computer-readable instructions such that, when executed, causes a processor to:
receive a location-based transfer request from a first user device associated with a first user, wherein the location-based transfer request comprises at least an identification of a location via a global positioning satellite (GPS) system, a transfer amount, and an identification of a second user, wherein the second user is a recipient of the location-based transfer request;
determining that a second user device is at the location based on location data identifying a location of the second user device, wherein the second user device is associated with the second user; and
in response to determining that the second user device is at the location and regardless of a location of the first user device, initiate a transfer of the transfer amount to an account associated with the second user.
